(19) United States
(12) Patent Application Publication
(10) Pub. No.: US 2025/0095911 A1
(43) Pub. Date: Mar. 20, 2025

(54) FUSE TRIPPING ACCELERATION ARRANGEMENT, CURRENT TRANSFORMER ARRANGEMENT AND ENERGY STORAGE SYSTEM

(71) Applicant: TRUMPF Huettinger GmbH + Co. KG, Freiburg (DE)

(72) Inventor: Ansgar Schuler, Stegen (DE)

(21) Appl. No.: 18/963,845

(22) Filed: Nov. 29, 2024

Related U.S. Application Data
(63) Continuation of application No. PCT/EP2023/064037, filed on May 25, 2023.

(30) Foreign Application Priority Data
Jun. 3, 2022 (DE) 10 2022 114 140.3

(51) Int. Cl. H01F 27/40; H01F 38/24; H01F 38/28

(52) U.S. Cl. CPC H01F 27/402; H01F 38/24; H01F 38/28

(57) ABSTRACT

A fuse tripping acceleration arrangement for being arranged between a bidirectional voltage transformer of a current transformer device and an energy store having at least one electrochemical energy converter is provided. The fuse tripping acceleration arrangement includes two energy-store-side connections, two current-transformer-side connections, at least one fuse connected between one of the two energy-store-side connections and one of the two current-transformer-side connections, and an energy storage device with a predetermined internal resistance. The energy storage device is electrically connected in parallel with the two energy-store-side connections.

### CROSS REFERENCE TO RELATED APPLICATIONS

This application is a continuation of International Application No. PCT/EP2023/064037 (WO 2023/232627 A1), filed on May 25, 2023, and claims benefit to German Patent Application No. DE 10 2022 114 140.3, filed on Jun. 3, 2022. The aforementioned applications are hereby incorporated by reference herein.

### FIELD

Embodiments of the present invention relate to a fuse tripping acceleration arrangement, designed for arrangement between a bidirectional voltage transformer of a current transformer device and an energy store having at least one electrochemical energy converter, in particular an energy converter in the form of a flow battery, for example a redox-flow battery. Embodiments of the invention also relate to a current transformer arrangement and an energy storage system.

### BACKGROUND

Alternative energies are becoming more and more important. The problem with alternative energies, for example solar energy or wind power, is that the times for energy production should not be influenced and excess energy needs to be temporarily stored so that it is available at times when no energy can be generated. It is therefore necessary to use energy storage systems. A suitable energy store is a flow battery or an electrochemical energy converter for a flow battery, in particular a redox-flow battery with a circulation arrangement for electrolytes, electrolyte lines for the supply and discharge of one or more electrolytes from a storage tank to the electrochemical energy converter and furthermore back into the respective storage tank in the form of a circuit process, wherein the electrochemical energy converter comprises at least one reaction cell with two electrodes and an ion-conducting membrane, preferably a multiplicity of electrically interconnected individual cells, wherein these cells are preferably supplied with electrolytes in parallel and each have an inlet region for introducing the electrolyte into the reaction cell and an outlet region for discharging the electrolyte from the reaction cell.

A current transformer device for charging and discharging an energy store has been disclosed for example in DE 10 2014 100 989 B4. A current transformer device for charging and discharging energy stores in the form of flow batteries, in particular redox-flow batteries, is disclosed here. The current transformer device in this case has a bidirectional voltage transformer, which is connected to a power supply network and to at least one electrochemical energy converter, wherein the current transformer device has a controller, which is connected to the voltage transformer and can control the voltage transformer in terms of its power flow direction and multiple energy storage peripheral devices depending on the power flow direction of the voltage transformer specified by the controller. These energy storage peripheral devices may be for example: pumps for circulating the electrolyte of the flow batteries, flow regulators for regulating the electrolyte flow rate, temperature controller for adjusting the electrolyte temperature or pressure controller for adjusting the electrolyte pressure.

If a voltage source, for example a previously mentioned energy store, is short-circuited in or on the way to the consumer, for example a previously mentioned current and/or voltage transformer, this produces a current flow which is normally able to trip a fuse that is electrically arranged and connected between the voltage source and the consumer. The term ‘fuse’ here refers to an electrical overcurrent protection apparatus, that is to say a protection apparatus designed to reduce or interrupt the current flow in the event of overcurrent. This is also referred to as ‘tripping’. Fuses of this kind are usually designed to trip in accordance with a specified time-current characteristic curve. For example, a small overcurrent often leads to the fuse tripping only after a significantly longer time than a significantly higher overcurrent measured against the small overcurrent. A fuse of this kind is described for example in DE 10 2019 131 533 A1. It becomes difficult if the short-circuit impedance of the voltage source does not differ greatly from the normal impedance. In the case of a redox-flow battery as the voltage source or energy store, the internal resistance is often in the double-digit mOhm range. As a result, the expected short-circuit current is only a few factors higher than the expected load current in the unfavourable case, for example at a low charging voltage. As a result, fuses cannot be tripped or can be tripped only very slowly, for example only after several seconds. If the fuse is dimensioned only just above the rated current, this results in a high power loss (medium double-digit watt range) and reduced service life for normal operation.

### SUMMARY

Embodiments of the present invention provide a fuse tripping acceleration arrangement for being arranged between a bidirectional voltage transformer of a current transformer device and an energy store having at least one electrochemical energy converter. The fuse tripping acceleration arrangement includes two energy-store-side connections, two current-transformer-side connections, at least one fuse connected between one of the two energy-store-side connections and one of the two current-transformer-side connections, and an energy storage device with a predetermined internal resistance. The energy storage device is electrically connected in parallel with the two energy-store-side connections.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an energy storage system having a fuse tripping acceleration arrangement according to some embodiments; and

FIG. 2 shows a fuse tripping acceleration arrangement according to some embodiments.

### DETAILED DESCRIPTION

Embodiments of the present invention provide an improved fuse option for energy storage systems which have an electrochemical energy store.

According to some embodiments, a fuse tripping acceleration arrangement, designed for arrangement between a bidirectional voltage transformer of a current transformer device and an energy store having at least one electrochemical energy converter, in particular an energy converter in the form of a flow battery, for example a redox-flow battery, wherein the fuse tripping acceleration arrangement comprises:
two energy-store-side connections,
two current-transformer-side connections,
at least one fuse which is connected between one of the energy-store-side connections and one of the current-transformer-side connections, and
an energy storage device with a predetermined internal resistance and which is electrically connected in parallel with the energy-store-side connections.

Through this measure, the energy storage device is connected in parallel with the energy store and thus effectively reduces the internal resistance of the energy store. This means that the fuse can be dimensioned in such a way that it reliably trips in the event of a short circuit, but no significant losses occur during normal operation. The fuse tripping acceleration arrangement can be easily retrofitted in existing energy storage systems.

An energy storage device is understood here to be a storage device which is designed to store electrical energy. It may be designed in particular as a voltage source.

The energy storage device may be designed in terms of its spatial dimensions multiple times smaller than the energy store having at least one electrochemical energy converter, in particular the energy converter in the form of a flow battery, for example a redox-flow battery. It may be smaller by a factor of 100 or more.

The energy storage device may be designed in terms of its electrical capacitance multiple times smaller than the energy store having at least one electrochemical energy converter, in particular the energy converter in the form of a flow battery, for example a redox-flow battery. It may be smaller by a factor of 100 or more.

The energy storage device may be designed in terms of its weight multiple times smaller than the energy store having at least one electrochemical energy converter, in particular the energy converter in the form of a flow battery, for example a redox-flow battery. It may be smaller by a factor of 100 or more.

Reliable tripping of the fuse can be achieved when the internal resistance of the energy storage device is lower than the internal resistance of the energy store, in particular is lower than the internal resistance of the energy store by a factor of 10, preferably by a factor of 20.

Further advantages result when the internal resistance of the energy storage device is at least so low that a current through the fuse in the case of a current-transformer-side short circuit is greater than the rated load current by a factor of 2 or more when the energy store is charged or discharged. The internal resistance of the energy storage device may be in the range of 1 mOhm.

When the internal resistance of the energy storage device is lower than the internal resistance of the voltage transformer, this also contributes to reliable tripping of the fuse.

The internal resistance of the energy storage device may at least approximately correspond to the line resistance of a conductor between the energy store and the current transformer device, in particular a conductor between an energy-store-side connection and a current-transformer-side connection.

The energy storage device may be in the form of a capacitor. This results in a simple design of the energy converter device. For example, the capacitor may be in the form of an electrolytic capacitor.

A further fuse may be arranged between the respective other of the energy-store-side and the current-transformer-side connections. An energy storage system having a fuse tripping acceleration arrangement according to embodiments of the invention thus becomes even more reliable.

Embodiments of the invention also provide a current transformer arrangement, which comprises:
a current transformer device for charging and discharging an energy store having at least one electrochemical energy converter, in particular an energy converter in the form of a flow battery, for example a redox-flow battery, having at least one bidirectional voltage transformer and
a fuse tripping acceleration arrangement according to embodiments of the invention, which is connected to the bidirectional voltage transformer by way of the current-transformer-side connections thereof and can be connected to the electrochemical energy transformer by way of the energy-store-side connections thereof.

This results in the advantages described above.

Embodiments of the invention also relate to an energy storage system having a current transformer device, which has at least one bidirectional voltage transformer, and an energy store, which is connected to the bidirectional voltage transformer and has at least one electrochemical energy converter, wherein a fuse tripping acceleration arrangement according to embodiments of the invention is arranged between the bidirectional voltage transformer and the energy store.

An energy storage system of this kind may be operated with low losses and quickly transferred to a safe state in the event of short circuits.

The energy store may comprise multiple electrochemical energy converters that are electrically connected in parallel or in series. The energy store may be in the form of a stack.

Further features and advantages of the embodiments of the invention are evident from the following detailed description of exemplary embodiments, with reference to the figures of the drawing. The features shown there are to be understood as not necessarily to scale. The various features may be realized in each case individually by themselves or as multiples in any desired combinations.

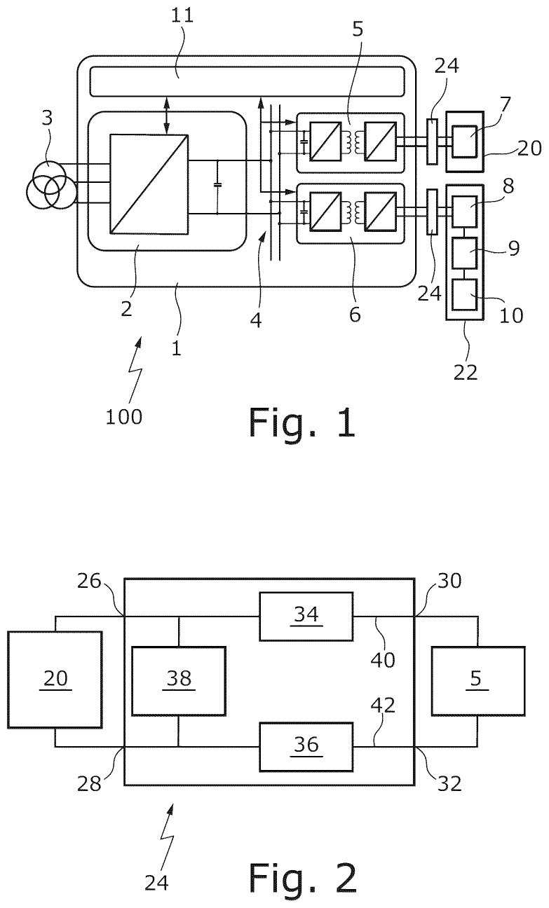

FIG. 1 shows an energy storage system 100 having a current transformer device 1, which has a first voltage transformer 2, which is able to be connected to a single-phase or multi-phase power supply network 3. The first voltage transformer 2 may in particular be in the form of a bidirectional AC/DC transformer. It is connected to a link 4 to which a second and a third voltage transformer 5, 6 are connected in turn. The voltage transformers 5, 6 may for example be in the form of in particular bidirectional DC/DC transformers and may each convert over 5 kW of power. DE 10 2014 100 989 B4 describes how the voltage transformers 5, 6 can be designed, for example.

More than the two voltage transformers 5, 6 shown may be connected to the link 4. The voltage transformers 5, 6 are each connected to an energy store 20, 22. The energy stores 20, 22 may comprise one or more electrochemical energy converters 7 to 10, wherein, in the embodiment shown, the voltage transformer 5 is connected to the electrochemical energy converter 7 and the voltage transformer 6 is connected to the electrochemical energy converters 8 to 10. The electrochemical energy converters 8 to 10 are interconnected in series. They could also be connected in parallel with the voltage transformer 6.

The voltage at the link 4 may be significantly higher than the voltage at the energy converters 7 to 10. This makes the current transformer device 1 efficient.

Furthermore, the current transformer device 1 has a controller 11, which is connected both to the first voltage transformer 2 and to the voltage transformers 5, 6 and is set up to control same. In particular, the controller 11 is set up to control the power flow, in particular the direction of the power flow, in the voltage transformers 5, 6. In this case, the controller 11 can control the voltage transformers 5, 6 in such a way that for example energy from the electrochemical energy converter 7 is transferred via the voltage transformer 5, the link 4 and the voltage transformer 6 to the electrochemical energy converter 8 or vice versa. During this transfer, the controller 11 can disconnect the voltage transformer 2.

Furthermore, the controller 11 can control the voltage transformers 2, 5, 6 in such a way that power flows from the power supply network 3 via the voltage transformer 2, the link 4 and the voltage transformers 5, 6 to the electrochemical energy converters 7 to 10. The controller 11 may in this case also control only one of the voltage transformers 5, 6 so that for example only one energy transfer to the energy converter 7 takes place. Furthermore, the controller 11 can control the power flow in such a way that for example energy stored in the energy converter 7 is fed into the power supply network 3 via the voltage transformer 5, the link 4 and the voltage transformer 2.

A respective fuse tripping acceleration arrangement 24, which is described with reference to FIG. 2, is arranged between the current transformer device 1 and each energy store 20, 22.

FIG. 2 shows a fuse tripping acceleration arrangement 24 in detail. The fuse tripping acceleration arrangement 24 has two energy-store-side connections 26, 28 and two current-transformer-side connections 30, 32. A first fuse 34 is arranged between the connections 26, 30. An optional second fuse 36 is arranged between the connections 28, 32. An energy storage device 38 in the form of a voltage source is connected in parallel with the energy-store-side connections 26, 28.

The energy storage device 38 may in particular be in the form of a capacitor, for example an electrolytic capacitor. The energy storage device 38 has an internal resistance which is significantly lower than the internal resistance of the energy store 20. For example, the internal resistance of the energy storage device is 1 mOhm and the internal resistance of the energy store 20 is 20 mOhm.

The lines 40, 42 may each have a line resistance in the range of the internal resistance of the energy storage device 38. For example, the lines 40, 42 may have a line resistance of 1 mOhm. The internal resistance of the energy storage device 38 is preferably lower than the internal resistance of the voltage transformer 5. For example, the internal resistance of the voltage transformer 5 may be 3 mOhm.

By virtue of the fact that the energy storage device 38 is connected in parallel with the energy store 20, the internal resistance of the energy store 20 is effectively reduced. This causes the fuse 34 (and the fuse 36) to trip reliably and quickly in the event of a short circuit. The internal resistance of the energy storage device 38 may be in the range of 1/100-1/10 of the internal resistance of the energy store 20.

The energy storage device 38 preferably has a sufficient capacitance to reliably be able to trip the fuse 34, 36 in the event of a short circuit.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A fuse tripping acceleration arrangement for being arranged between a bidirectional voltage transformer of a current transformer device and an energy store having at least one electrochemical energy converter, the fuse tripping acceleration arrangement comprising:
two energy-store-side connections,
two current-transformer-side connections,
at least one fuse connected between one of the two energy-store-side connections and one of the two current-transformer-side connections, and
an energy storage device with a predetermined internal resistance, wherein the energy storage device is electrically connected in parallel with the two energy-store-side connections.

2. The fuse tripping acceleration arrangement according to claim 1, wherein the predetermined internal resistance of the energy storage device is lower than an internal resistance of the energy store.

3. The fuse tripping acceleration arrangement according to claim 2, wherein the predetermined internal resistance of the energy storage device is lower than the internal resistance of the energy store by a factor of 10.

4. The fuse tripping acceleration arrangement according to claim 2, wherein the predetermined internal resistance of the energy storage device is lower than the internal resistance of the energy store by a factor of 20.

5. The fuse tripping acceleration arrangement according to claim 1, wherein the predetermined internal resistance of the energy storage device is low enough that a current through the at least one fuse in case of a current-transformer-side short circuit is greater than a rated load current by a factor of 2 or more when the energy store is charged or discharged.

6. The fuse tripping acceleration arrangement according to claim 1, wherein the predetermined internal resistance of the energy storage device is lower than an internal resistance of the voltage transformer.

7. The fuse tripping acceleration arrangement according to claim 1, wherein the predetermined internal resistance of the energy storage device at least approximately corresponds to a line resistance of a conductor between the energy store and the current transformer device.

8. The fuse tripping acceleration arrangement according to claim 7, wherein the conductor is between one of the two energy-store-side connections and one of the two current-transformer-side connections.

9. The fuse tripping acceleration arrangement according to claim 1, wherein the energy storage device is in a form of a capacitor.

10. The fuse tripping acceleration arrangement according to claim 1, further comprising a further fuse arranged between another one of the two energy-store-side connections and another one of the two current-transformer-side connections.

11. A current transformer arrangement, comprising:
a current transformer device for charging and discharging an energy store, the energy store comprising at least one electrochemical energy converter, the current transformer device comprising at least one bidirectional voltage transformer, and
a fuse tripping acceleration arrangement according to claim 1, wherein the fuse tripping acceleration arrangement is connected to the bidirectional voltage transformer by the two current-transformer-side connections thereof and is capable of being connected to the electrochemical energy converter by the two energy-store-side connections thereof.

12. An energy storage system comprising:
a current transformer device comprising at least one bidirectional voltage transformer,
an energy store connected to the at least one bidirectional voltage transformer, the energy store comprising at least one electrochemical energy converter, and
a fuse tripping acceleration arrangement according to claim 1 arranged between the bidirectional voltage transformer and the energy store.

13. The energy storage system according to claim 12, wherein the energy store comprises multiple electrochemical energy converters that are electrically interconnected in parallel or in series.
